(19) United States
(12) Patent Application Publication
(10) Pub. No.: US 2002/0135238 A1
(43) Pub. Date: Sep. 26, 2002

(54) Finger operated control panel

(76) Inventor: Stephen Cole, Huntington Station, NY (US)

Correspondence Address: GREENBERG & LIEBERMAN, 314 PHILADELPHIA AVE., TAKOMA PARK, MD, 20912, US

(21) Appl. No.: 10/063,116

(22) Filed: Mar. 22, 2002

Related U.S. Application Data
(60) Provisional application No. 60/277,623, filed on Mar. 22, 2001.

(51) Int. Cl. H02H 1/00

(52) U.S. Cl. 307/326

(57) ABSTRACT

A finger operated control panel for electrically operated equipment that has safety measures to assure that the machinery cannot be left unattended while in operation. Pressure must be applied to the touch sensitive metallic disc in order for the machinery to operate.

### CROSS REFERENCE TO RELATED APPLICATIONS

Priority is hereby claimed to provisional patent application No. 60/277623 filed on Mar. 22, 2001.

### BACKGROUND OF INVENTION

There are many security control panels on the market that can be used on machinery. There are control panels for cranes and other heavy equipment that require a key, and have a warning label posted for those who may not know how to operate the machinery. There are keypad systems to operate automatic doors as in secure parts of a bank, or executive offices.

In companies that have machinery that can harm persons if operated by someone who is not properly trained, access to that machinery is often limited. For example, folding partition systems that are mechanically activated in gymnasiums are operated by use of key control stations. Key control stations allow the operator to ascertain whether there are blockages to the partitions before opening or closing and to observe the area during operation. Many of these systems are key operated, which can create a dangerous situation if the operator inserts the key to move the partition and walks away from the key switch. If the operator walks away from the operation of the partition system, a child can wander into the path of the partition and become entangled in the moving panels, and become seriously injured.

U.S. Pat. No. 4,922,168 issued to Waggamon, et al., on May 1, 1990 shows a Universal Door Safety System. Waggamon's invention is unlike the present invention because it is a mechanism for stopping a garage door if an obstruction is in the path of the door, and does have a control panel requiring constant pressure to activate and operate machinery.

U.S. Pat. No. 5,404,959 issued to Adkins, Sr. et al., on Apr. 11, 1995 shows a Drill Rig Shut Down Device. Adkins' invention is unlike the present invention because it functions only in engines with solenoids, and it does not have a finger pressure operated panel that requires a user to press the button to operate the machinery, and does not require constant pressure to allow the machinery to operate.

U.S. Pat. No. 5,572,075 issued to Campbell, et al., on Nov. 5, 1996 shows a Safety Lock Apparatus. Campbell's invention is unlike the present invention because it does not have a finger pressure operated button that must be pushed for the machinery to function. Also Campbell's invention requires electromagnetic and fiber optic means to operate.

Therefore a need has been established for a control pad system for partitions that requires the operator to remain at the control panel during operation.

### SUMMARY OF THE INVENTION

The present invention is ainger operated control panel for electrically operated equipment that has safety measures to assure that the machinery cannot be left unattended while in operation. Pressure must be applied to the touch sensitive metallic disc in order for the machinery to operate. The finger operated control panel can be applied to any moving machinery. The present invention also includes LED displays to clearly show the operator which direction, i.e. reverse or forward, that the equipment is moving. Also included is a clear written warning for the operator to never leave the equipment unattended.

### BRIEF DESCRIPTION OF DRAWINGS

FIG. 1 is a frontal view of the present invention.

FIG. 2 is a side view of the present invention.

FIG. 3 is an elevational view of the present invention.

### DETAILED DESCRIPTION

The present invention is a finger operated control panel. The present invention has a base plate (110), a pair of LED displays (30), a key control switch (20), a finger touch sensitive metallic pad (50), a warning label (60), tamper resistant fasteners (40), an operations label (90), a series of wiring (160) and an identifying label (100).

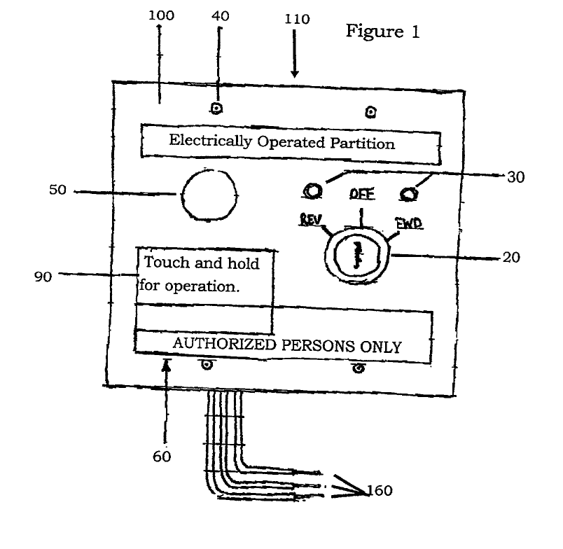

FIG. 1 shows a frontal view of the base plate (110). The base plate (110) is constructed of metal or another sturdy material, and can be constructed in varying sizes to meet the needs of the individual partition system, accommodating the separate switches as necessary. The base plate (110) protects the wiring and accommodates covers for the LED displays (30). The base plate (110) also covers the wiring and power mechanisms of the present invention. The two LED displays (30) are clearly marked to show which direction the machinery is currently moving. The two directions exhibited in this embodiment are “reverse” and “forward”, but the present invention can be customized to meet any needs of partition systems that may move in other directions. The LED displays (30) can also be of any shape or color, as long as they are easily visible to the operator. There is a key control switch (20) that has conventional means to begin the electrical relay to move the partitions. The warning label (60) clearly states a message in English and/or any other applicable language that states:

WARNING: NEVER LEAVE EQUIPMENT UNATTENDED DURING OPERATION! or AUTHORIZED PERSONS ONLY, or another applicable warning.

The conventional fasteners (40) are screws or other removable yet secure means to attach the control station. There is a finger touch sensitive operated metallic pad (50) that must have pressure applied to operate the machinery. The finger pressure operated metallic pad (50) is designed to have no moving parts that can be manipulated to disarm the device. The trip associated with the finger pressure operated metallic pad (50) is in direct communication with the remote control panel associated with the electronically operated equipment. In this manner the machinery cannot be operated without the user applying constant pressure to the finger pressure operated metallic pad (50). The operator can not leave the machinery unattended without the machinery powering down immediately. This safety measure creates a situation in which injuries due to unattended machinery are totally eliminated. The operations label (90) gives instructions to the user for operation of the finger pressure operated metallic pad (50). The operations panel (90) clearly states in English, or other applicable language “Touch and hold for operation.”

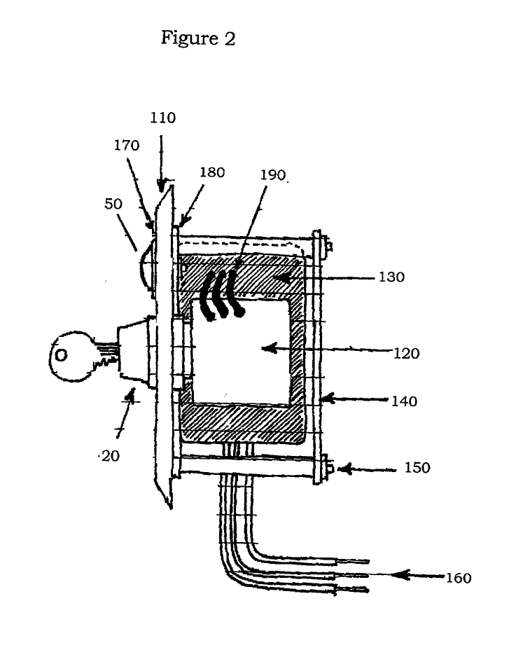

Also shown in FIG. 1, is the series of wiring (160). The wiring transmits power to the LED displays (30), and the finger pressure operated metallic pad (50). The series of wiring (160) is connected to the electrical wiring of the building. The series of wiring (160) does not circulate power to the finger pressure operated metallic pad (50) and the LED displays (30) until the present invention is activated by the insertion of the key into the key control switch (20) and pressure is applied to the finger pressure operated metallic pad (50). The identifying label (100) clearly marks the control station so a user may easily view which FIG. 2 shows a side view of the present invention. The base plate (110) is shown as connected to the inner wiring of the building. The electrical contacts (120) are activated by the activation of the key control switch (20). The electrical contacts (120) can be powered from voltages from 12 volts to 240 volts, depending on the voltage needed and supplied by the building, and the electrically operated partition. The pressure sensitive electrical components (130) are shown in the body of the present invention. The pressure sensitive electrical components (130) are activated, and the circuit is completed, only when the pressure is applied to the finger pressure sensitive switch (50). The non-metallic cover plate (140) is shown at the rear of the present invention. The non-metallic cover plate (140) is made of a non-conductive material such as a ceramic plate, but is not limited thereto. Conventional fasteners (150) are shown to attach the non-metallic cover plate (140) to the rear section of the present invention. The conventional fasteners (150) can be screw, bolt, nut, or wing nut attachments as long as they are removable fasteners. The series of wiring (160) leads to a conventional electrical box of the building, remotely located from the present invention. The series of wiring (160), as attached to the conventional 120 volt AC electrical box (not shown) is the power source of the electrical components of the present invention. A non-metallic insulating spacer (170) is included to impede the direction of electrical current to the exterior of the present invention.

Also shown in FIG. 2 is the circuit board (180) as mounted to the base plate (110) and is directly connected to the pressure sensitive electrical components (I30). The circuit board (180) relays the message from the finger pressure operated metallic pad (50), when pressure has been applied, to the pressure sensitive electrical components (130). There is also a series of inner wiring (190) which connects the electrical contacts (120) of the key control switch (20) to the pressure sensitive electrical components (130).

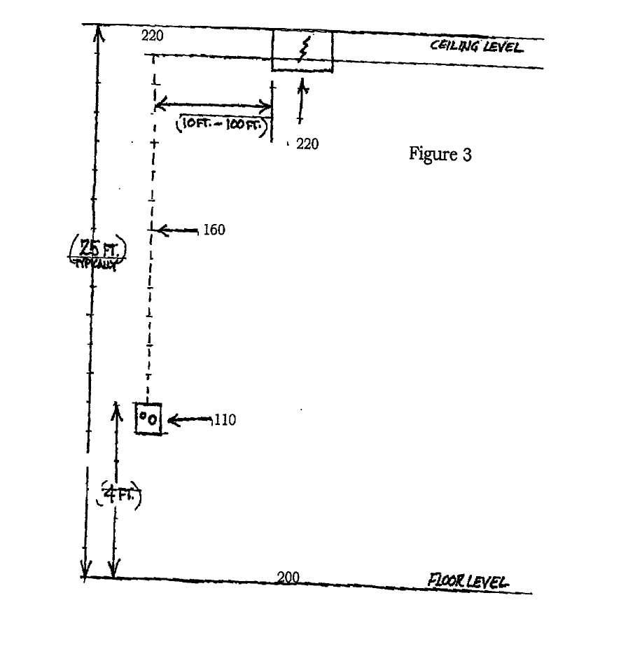

FIG. 3 shows an environmental view of the present invention as mounted in a room. The base plate (110) is shown mounted approximately 4 feet from the floor (200). The series of wiring (160) is shown connected to the remote electrical box (210) as connected to the ceiling (220). The series of wiring (160) can extend any needed distance to the remote electrical box (210). The base plate is placed within easy reach of adults, but is at a height that would be hard to reach for children.

The present invention is not limited to the embodiments described above, but encompasses any and all of the embodiments in the following claims.

1. A safety device for controlling electronically operated panels, comprising:
a base plate;
a pressure sensitive disc enclosed in said base plate;
a key switch enclosed in said base plate;
a series of wiring for supplying current to said pressure sensitive disc and said key switch; and
a remote power unit attached by said series of wiring to said key switch and said pressure sensitive disc.

2. A safety device as in claim 1, further comprising at least two light emitting diodes enclosed in said base plate.

3. A safety device as in claim 2, wherein said at least two light emitting diodes denote the direction of movement of the electrically operated panels.

4. A safety device as in claim 3, wherein said series of wiring is connected to said at least two light emitting diodes.

5. A safety device as in claim 1, further comprising a warning label attached to said base plate.

6. A safety device as in claim 1, further comprising an operation instruction label attached to said base plate.

7. A safety device as in claim 1, wherein said remote power unit is attached to the wiring of a building in which the electronically operated panels are installed.

8. A safety device as in claim 1, wherein an operator must insert and turn a key in said key switch, and apply pressure to said pressure sensitive disc congruously to activate the electronically operated panel.

9. A safety device for controlling electronically operated panels, comprising:
a base member;
a pressure sensitive member enclosed in said base member;
a switch enclosed in said base member; and
a power supply in communication with said pressure sensitive member and said switch.
